(19) United States
(12) Patent Application Publication
(10) Pub. No.: US 2009/0249128 A1
(43) Pub. Date: Oct. 1, 2009

(54) PREDICTIVE DIAGNOSTICS SYSTEM, APPARATUS, AND METHOD FOR IMPROVED RELIABILITY

(76) Inventors: Randy L. Heckman, Fort Collins, CO (US); Daniel C. Carter, Fort Collins, CO (US); Victor L. Brouk, Fort Collins, CO (US)

Correspondence Address: Neugeboren O'Dowd PC, 1227 Spruce Street, SUITE 200, BOULDER, CO, 80302, US

(21) Appl. No.: 12/058,709

(22) Filed: Mar. 30, 2008

(51) Int. Cl. G06F 11/30

(52) U.S. Cl. 714/47; 714/E11.179

(57) ABSTRACT

A system for managing a processing system and/or a processing system component is described. The system may include a wear-out module configured to provide a wear-out signal, the wear-out signal indicating a remaining amount of useful life of the component; a health module configured to provide a health signal, the health signal indicating an extent to which operational and environmental factors affect a failure rate of the component during a useful life of the component; and a mission module configured to provide a mission signal, the mission signal indicative of whether an operating condition is approaching a threshold that would adversely affect the system's ability to meet at least one performance objective.

### FIELD OF THE INVENTION

This invention relates generally to apparatus and methods for analyzing conditions of processing systems, and more particularly to apparatus and methods for predictive diagnostics in plasma processing or power conversion systems.

### BACKGROUND OF THE INVENTION

Advanced equipment control (AEC) and advanced process control (APC) systems have become commonplace in modern day semiconductor fabrication lines and other advanced manufacturing facilities, providing feedback and feedforward control for enhanced processes as well as detecting faults in hardware and in critical process steps. Unfortunately, real-time monitoring of the state of critical components and auxiliary equipment sub-systems is not adequately leveraged using conventional process sensor technologies. This results in poor visibility of many detectible, component-level faults and in reporting failures only after an event has occurred.

One type of critical auxiliary equipment sub-system utilized in semiconductor and other advanced manufacturing systems, is a plasma power delivery system. This system may comprises DC and/or RF generators, match networks, external power/impedance sensors, and any other components located in the path between the power source and the processing plasma. Recognized as an early indicator to changes in tool performance, plasma power systems have been externally instrumented to provide insight to degradation of tool performance and rapid indication of the general location of a fault, but this is not sufficient.

As a consequence, known techniques are often inadequate to provide failure prediction and process-system performance-information. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment the invention may be characterized as a system for managing a processing system. The system may include a wear-out module configured to provide a wear-out signal, the wear-out signal indicating a remaining amount of useful life of the component; a health module configured to provide a health signal, the health signal indicating an extent to which operational and environmental factors affect a failure rate of the component during a useful life of the component; and a mission module configured to provide a mission signal, the mission signal indicative of whether an operating condition is approaching a threshold that would adversely affect the system's ability to meet at least one performance objective.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram depicting components of an exemplary embodiment of the invention;

FIG. 2 is a block diagram depicting an exemplary environment in which the modules depicted in FIG. 1 may be employed;

FIG. 3 is a block diagram depicting another exemplary environment in which the modules depicted in FIG. 1 may be employed;

FIG. 4 is a flowchart that depicts an exemplary method that may be carried out in connection with the embodiments depicted in FIGS. 1-3;

FIG. 5 is a graph depicting failure rate of a hypothetical product; and

FIGS. 6A, 6B, and 6C are exemplary graphs depicting reported measures of remaining life of a component, health of the component, and a mission factor for the component, respectively.

### DETAILED DESCRIPTION

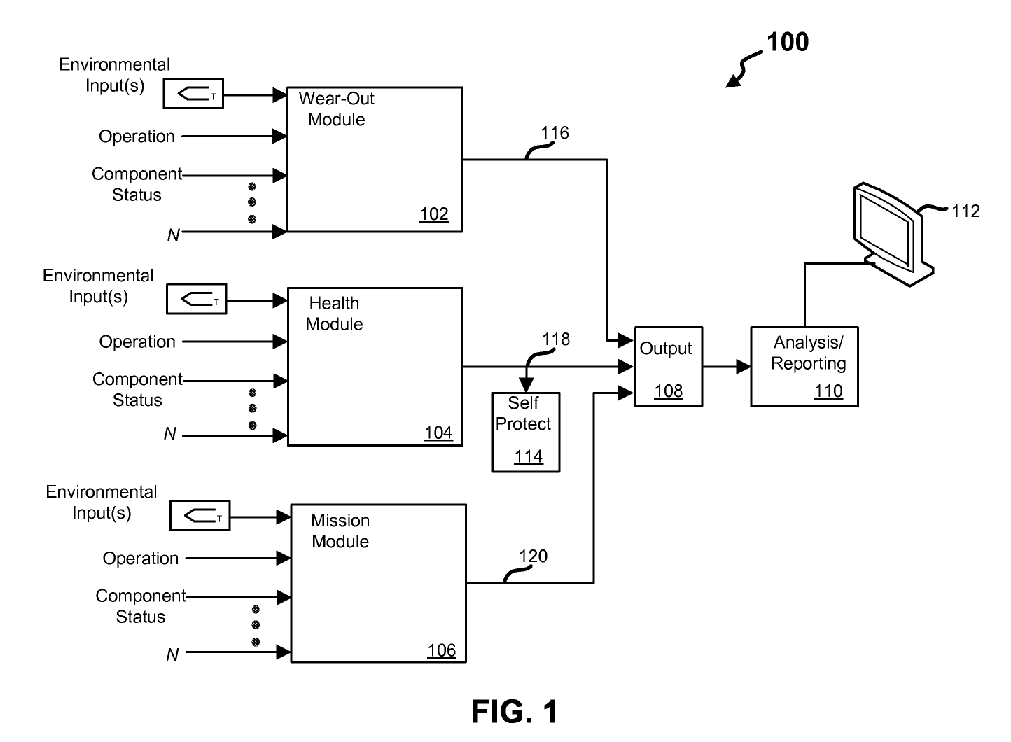

Referring now to the drawings, where like or similar elements are designated with identical reference numerals throughout the several views, and referring in particular to FIG. 1, it is a block diagram 100 depicting an exemplary system which may be utilized to provide indicators of the operational state, health and performance of a component or sub-system within a processing system.

As depicted, a wear-out module 102, a health module 104, and a mission module 106 are each coupled to an output module 108, which is coupled to an analysis/reporting module 110. As shown, each of the modules 102, 104, 106 in this embodiment receive N inputs, which may include environmental inputs, operational inputs, and status inputs. As depicted, the analysis/reporting portion 110 is also coupled to a man-machine interface 112, which may include a keyboard, display and pointing device (e.g., a mouse).

The illustrated arrangement of these modules 102, 104, 106 is logical and not meant to be an actual hardware diagram; thus, the modules can be combined or further separated in an actual implementation, and the depicted components may be realized by software, hardware, firmware or a combination thereof. Moreover, it should be recognized that the modules 102, 104, 106 depicted in FIG. I are described in many embodiments as residing within components of a processing system, but this is not required and it is contemplated that the modules 102, 104, 106 may be distributed among disparate constructs within a processing system.

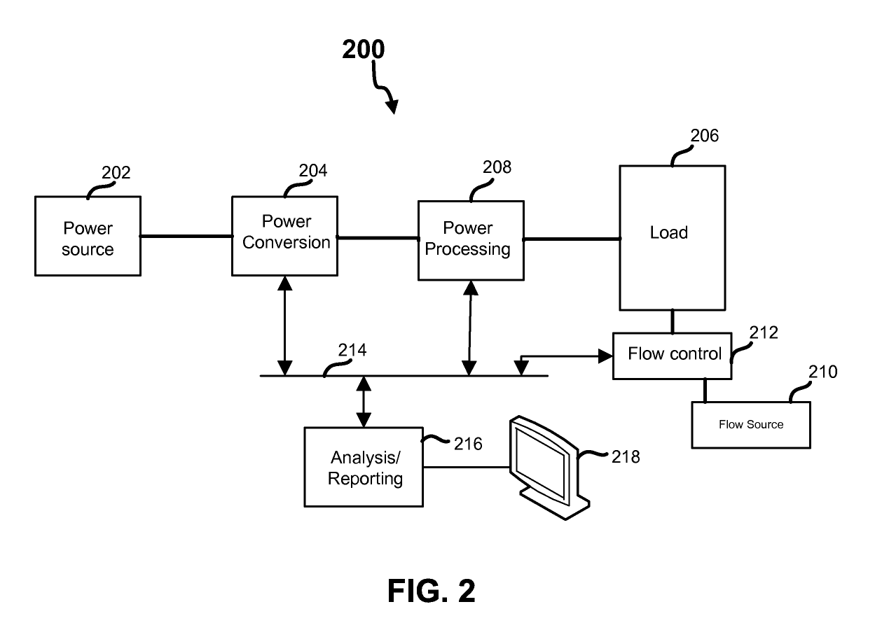

Referring briefly to FIG. 2, shown is a block diagram depicting an exemplary processing system 200 in which the embodiment depicted in FIG. 1 may be employed. As shown, a power source 202 is coupled to a power conversion component 204, and the power conversion component 204 is coupled to a load 206 via a power processing portion 208. Also shown is a flow source 210 that is configured to provide material to the load 206 by way of flow control component 212. As depicted, the power conversion component 204, the power processing component 208 and the flow control component 212 are coupled to an analysis/reporting portion 216, which is configured to receive reporting information from one or more of the components of the system via a network 214 and to use the information from the component(s) to control one or more aspects of the system 200 and/or to present the information for display 218.

The illustrated arrangement of these components is intended to generically represent a variety of processing systems in which the system depicted in FIG. 1 may be utilized, and as a consequence, some components may be omitted and/or other components added in the actual implementation. Depending upon the actual processing system, any or all of the depicted components 202, 204, 206, 208, 210, 212 may include an implementation of each of the modules 102, 104, 106 depicted in FIG. 1.

In some embodiments, the system 200 is a plasma processing system, and in these embodiments, the power source 202 corresponds to AC power (e.g., from a utility); the power conversion component 204 corresponds to a power generator (e.g., radio frequency (RF), mid-frequency, direct current (DC), or pulsed power); the power processing component 208 corresponds to an impedance matching network; the load 206 corresponds to a plasma load; the flow source corresponds to a material delivery device regulating the input of material to the flow control component 212 that corresponds to a mass flow controller.

In other embodiments, the system 200 is a photovoltaic power processing system, and in these embodiments the power source 202 corresponds to a photovoltaic array; the power conversion component 204 may correspond to a DC to DC converter and/or an inverter; the power processing component 208 may correspond to one or more power quality components; the load 206 corresponds to any one of a variety of loads; and the flow source 210 and 212 may not have a corresponding component or may correspond to any material source and material delivery component, respectively.

Referring again to FIG. 1, the wear-out module is generally configured to provide a wear-out signal 116 that is indicative of a remaining amount of useful life of a component. Modern processing systems are based on electronics that comprise power semiconductors, passive power circuits, and processor-based control logic. New materials and architectures have enabled longer operational life, with many wear-out mechanisms not occurring until well after the expected life of the product. Still, depending on the application, some known wear-out mechanisms can be accelerated.

Beneficially, the modules 102, 104, 106 in several embodiments receive an input indicative of conditions (e.g., operating conditions and environmental conditions) within the component itself. As a consequence, the modules are capable of providing much more useful information than sensors that are deployed around externally accessible portions of a processing system. Traditional equipment monitors, for example, are unable to detect or predict numerous process-critical behaviors because they lack fundamental contextual information only available within subsystem components.

One such example is the onset of plasma instabilities in the context of a plasma processing environment. Without information about the performance of the power amplifier's control and the impedance it experiences, such phenomena cannot be detected. Many embodiments of the system depicted in FIG. 1 take advantage of both conditions within a component and measurable conditions outside of a component that may affect the life, health and/or mission of the component.

In the context of a generator component (e.g., an RF generator) for example, one subcomponent of the generator that may be tracked is the power switching assembly (e.g., a field effect transistor (FET) assembly). In particular, solder fatigue can be predicted by monitoring temperature and power dissipation during power cycling, and it has been shown that wire bond failure causes a step function increase in die temperature at the onset of failure, and further that multiple-die package assemblies may continue to operate (at greater temperatures) for a brief time after the initial failure. Power cycles may be monitored to track remaining life.

Some additional subcomponents of generators or factors that influence them may be monitored. These subcomponents include vacuum tubes, contactors/relays, electrolytic capacitors, line suppressors, fans, fuses, air and water filters, water pumps, flow/water switches, meters and cold plates.

With respect to match network components, an example of a subcomponent that may be monitored is the variable vacuum capacitor. In this subcomponent, a primary wear-out mechanism is wear of the drive screw and nut, and to predict failure, the number of drive screw rotations may be tracked. Other mechanisms and subcomponents that may be tracked in a match network include vacuum capacitor bellows fatigue, and loss of vacuum, motors, fans, and fuses.

In the context of mass flow controllers, some mechanisms include valve seat, sensor wire/structure, and the valve actuator. And with respect to inverters, some mechanisms include power semiconductors modules, contactors/relays, electrolytic capacitors, line suppressors, fans, fuses, air and water filters, water pumps, flow/water switches, meters and cold plates.

In many embodiments, the wear-out signal 116 indicates a remaining amount of useful life of the component. In some implementations the wear out signal is derived by real-time tracking of one or more of the mechanisms affecting the useful life of the component. For example, environmental factors such as temperature and humidity that may affect the useful life of subcomponents may be tracked, and the operation (e.g., power cycles, drive screw rotations, hours of operation) of one or more of the subcomponents may be tracked. In addition, a status (e.g., the age) of one or more of the subcomponents may be tracked.

In many embodiments, the wear-out signal 116 is derived from several mechanisms, but is calculated to be an overall indication of the remaining useful life of the component. In other words, the combination of the information about the useful lives of the subcomponents is utilized to arrive at a signal that represents the useful life remaining of the product as a whole. In some of these embodiments, the wear-out signal 116 indicates the probability of failure of a subcomponent within the component that is most likely to fail.

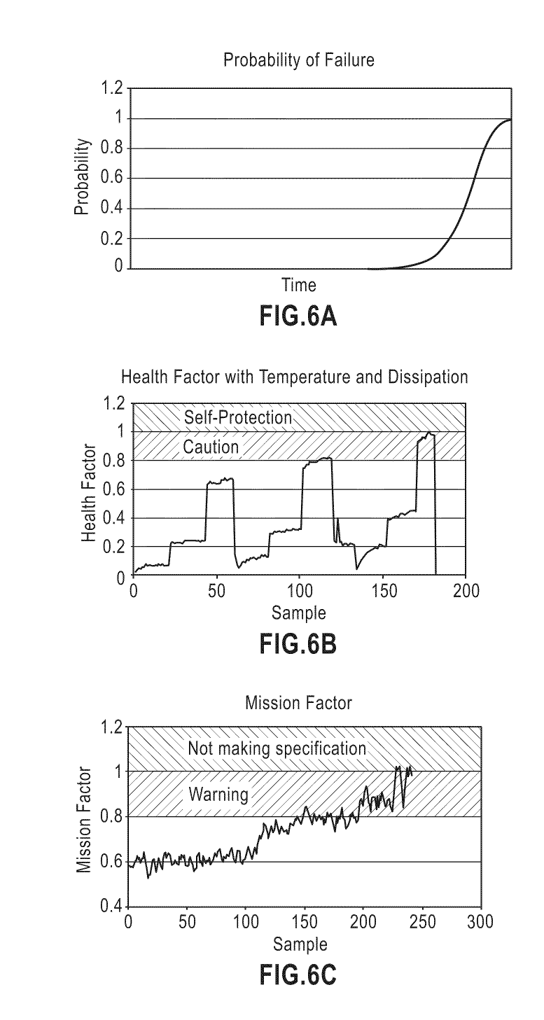

Although not required, in many embodiments the wear-out signal 116 indicates a probability that the component will fail due to wear-out. For example, the wear-out signal 116 may be a representation of a probability from zero to one. Referring briefly to FIG. 6A, for example, shown is an exemplary presentation of probability of failure of a component over time. At any given time, the wear out signal 116 may represent a point on the graph, which may be presented to a user.

In other embodiments the wear-out signal 116 indicates the remaining amount of useful life of the component by indicating an amount of useful life that has been utilized, and in yet other embodiments, the wear-out signal 116 indicates remaining useful life. It is contemplated that the resolution of the signal may be selected so as to provide many data points to a user. In many implementations, for example, at least three or more data points are provided, and in some embodiments the number of signal values may be a hundred or more values.

With respect to the health module 104, it is generally configured to provide a health signal 118 that indicates an extent to which operational and environmental factors affect a failure rate of the component during a useful life of the component.

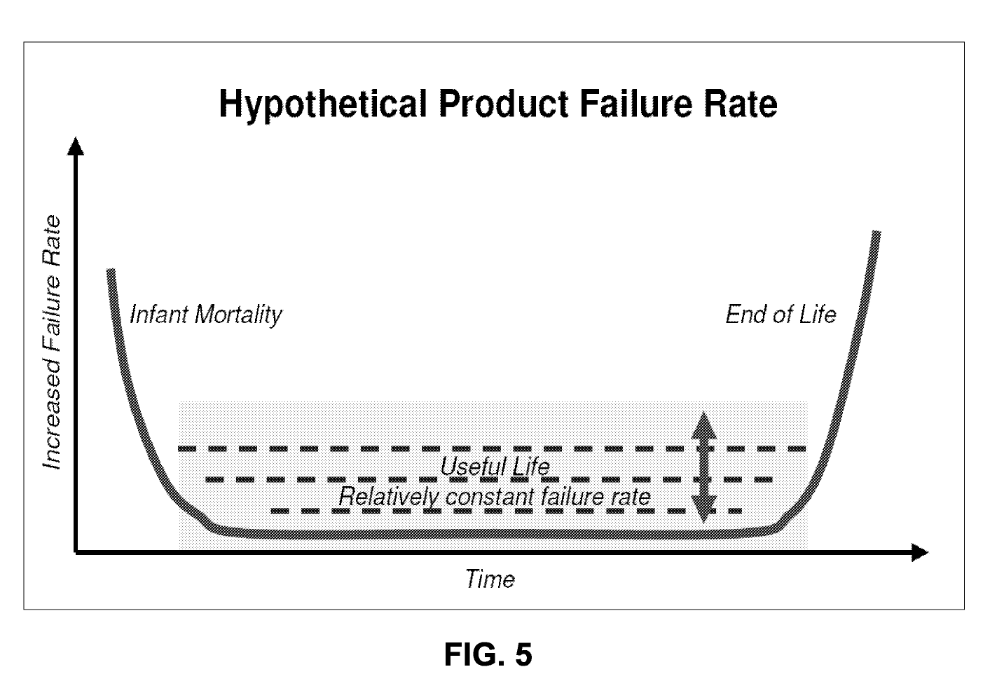

Processing system components are generally designed for a long useful life when operated into a well-maintained environment. Referring briefly to FIG. 5 for example, during a component's useful life, the failure rate is low, and theoretically occurs at a relatively constant rate. But several operational and environmental factors are known to increase the failure rate during the useful life. These factors together create a dynamic health “barometer” that can be used to define and maintain an operating environment that reduces deleterious affects upon the nominal useful life of the component.

In the context of power processing components (e.g., DC and RF generators), temperature and power dissipation have together shown to be predominant drivers for increasing the failure rate of processing system components. More specifically, and by way of example, ambient temperature, together with coldplate temperature and internal power dissipation of a generator have proven to be in reasonable agreement with an Arrhenius model to predict the failure acceleration of power products. The Arrhenius model has been internally validated when comparing results from accelerated life testing (ALT) and field data on known failure mechanisms. In accordance with the model, failure rate acceleration Ac may be expressed as:

$$Ac = exp [ \frac{E}{R} ( \frac{1}{T} - \frac{1}{{T}_{0}} ) ]$$

Where E is the apparent activation energy, R is the Boltzmann constant, T₀ is the baseline temperature, and T is the operating temperature (in Kelvin).

In some instances, the operational and/or environmental factors affect a failure probability to such an extent that a self protection fault is induced. Again by way of example, in the context of power generators, restricted water flow and dissipation due to load conditions can induce a self-protection fault. In particular, an impedance mismatch between the load and the generator can lead to increased dissipation, and when water flow to the generator is decreased, the affect upon the component health is compounded.

As depicted in FIG. 1, in some embodiments the system includes a self protect module 114 that is configured to protect the component (e.g., by initiating shutdown of the component). In other embodiments, however, the component includes self protection circuitry that operates independent from the system 100 depicted in FIG. 1.

Some additional environmental conditions and operational characteristics of subcomponents of generators and inverters that may be monitored include temperature, power cycles, humidity/condensation, power (energy), voltage (and charge), salt content in air, conductive dust, and arcing or other load disruptions. Correspondingly, it is contemplated that a variety of external sensors may be utilized in connection with the environmental and operational monitoring including temperature sensors, air flow sensors, water flow sensors, condensation sensors, current sensors, voltage sensors, and air conductivity sensors. It is also contemplated that the monitoring of certain operating conditions may be used to determine environmental conditions. For example, fan speed or current to the fan motor may be monitored because these conditions may be indicative of build up from a dusty environment.

In the context of impedance match networks, the vacuum capacitor cycle rate is an operating condition of a match subcomponent that may accelerate wear of the capacitor, and hence, affect the health of the match component. Improperly set tuning parameters can lead to capacitor “chatter” in an otherwise stable process. Such behavior can go unnoticed without direct monitoring of capacitor positions, and if corrective action is not taken, the chatter can rapidly accelerate wear on mechanical components in the vacuum capacitors.

Once detected, corrective action can be taken to properly adjust parameters; thus eliminating the issue and significantly prolonging the life of the match network components. Other environmental and operating conditions that may be monitored and utilized to arrive at the health signal are temperature, vacuum cap cycle rate, humidity/condensation, current, and plasma stability. U.S. Pat. No. 7,157,857 to Brouk et al., which is incorporated herein by reference, discloses techniques for determining the stability of a plasma load which may be utilized in connection with the system 100 to provide an input to one or more of the modules 102, 104, 106.

In the context of mass flow controllers, some environmental and operating conditions that may be utilized by the health monitor include temperature, valve cycles, power cycles, shock and vibrations, and supply voltage.

In many embodiments, the health signal 118 indicates an extent to which operational and environmental factors affect useful life failure probability of the component during a useful life of the component. In some embodiments, the health signal 118 is provided as a single summary health factor, which is derived from environmental conditions and operating conditions of a plurality of subcomponents within the component. Referring to FIG. 6B, for example, shown is an exemplary report that may be provided responsive to the health signal.

As shown, the health signal in this embodiment may include several potential values to enable generation of a health factor that provides a user with an indication of the degree to which health is affecting the useful life of a component. In the particular embodiment depicted in FIG. 6B, the health factor is normalized to limits where the product will self protect, but within, recognizes the non-linear relationship of temperature on the acceleration of the probability of failure. In this depiction, an RF generator's load is adjusted between three different impedances, each producing an increase in internal power dissipation, all while the external temperature is increasing. But this particular embodiment is certainly not required and it is contemplated that the health of a component may be presented in a variety of different forms.

The mission module 120 in the embodiment depicted in FIG. 1 is generally configured to provide a mission signal 120 that is indicative of whether an operating condition is approaching a threshold that would adversely affect the ability of the component to meet one or more performance objectives. In the context of a plasma processing system, the performance objective of a generator, for example, may be to convert power from line voltage and deliver it to the plasma load in a predefined, precisely controlled manner. And the performance objective of an impedance match network may be to match a plasma load to the impedance of a generator in accordance with predefined tuning parameters. With respect to an inverter, the performance objective may be to convert DC power (e.g., from a photovoltaic array) to an AC voltage that is regulated to provide clean reliable power according to predefined performance parameters. And in the context of a mass flow controller, the performance objective may be to provide a particular flow of material to a processing chamber within predefined tolerance levels.

Beneficially, the mission module in many embodiments utilizes information obtained from within the component (e.g., from within a generator, match, inverter, MFC, etc.) to arrive at the mission signal 120. Prior approaches that placed sensors throughout accessible portions of a process system simply can not do this. In the context of power systems for example, traditional equipment-monitors only consider the input and output of the power source, but ignore interactions from the rest of the system, including the reaction to plasma impedance.

The exemplary system 100, however, is disposed and configured to utilize internal control parameters and measures to enable the entire power system performance to be characterized from within a generator component. In a power system, closed-loop controls are used to maintain power delivery over a broad range of electrical input and output conditions, and environmental conditions. In many embodiments, internal control loop parameters are monitored for repeatability and proximity to limit conditions as a measure of the power system's ability to meet the performance criteria.

In the context of plasma processing for example, process drift increases plasma sensitivity to power perturbations, which increases the likelihood of instabilities. In several embodiments, measurement of any interaction between plasma impedance and power amplifier response may be carried out to allow for real time assessment of system stability and predictive determination of process margin.

Other environmental and operating conditions that may be monitored in a power processing system and utilized in connection with the generation of the mission signal include the extent of departure from a setpoint (e.g., load or line), the presence of arcing or excessive arc rates, marginal stability, proximity to electrical limit conditions, out of AC line limits (e.g., SEMI F47 compliance), and over temperature conditions.

In the context of a match network, the environmental and operating conditions that may be monitored include load impedance, load arcing, plasma stability, the proximity of capacitors to their operating limits, external arcing, voltage/current limits, and lack of plasma ignition. And the environmental and operating conditions that may be monitored relative to mass flow controllers include upstream and downstream pressure, upstream gas delivery system, and foreline pressure profiles. In the context of inverters, the environmental and operating conditions that may be monitored include photovoltaic array output, current balance, power grid quality, ground currents, control stability, proximity to electrical limit conditions, and over temperature conditions.

In some embodiments, the mission-signal 120 is utilized to generate a summary mission factor that may be generated from controls and system parameters. Referring to FIG. 6C, for example, shown is a depiction of an exemplary report generated from a mission-signal in which the output is normalized to system limits that indicate operating margin. In this depiction, an increasing flow of electronegative gas material into a powered plasma processing system reduces the margin of control stability, thereby approaching the operating condition where the power delivery will be unstable. In this way, a user may quickly assess whether there are any operating and/or environmental conditions that may adversely affect system performance.

As depicted in FIG. 1, an output portion 108 is configured to receive the wear-out signal 116, health signal 118, and mission signal 120 and provide information from the signals 116, 118, 120 to the reporting/analysis module 110 for reporting and/or control relative to one or more components of the processing system (e.g., processing system 200). In many embodiments, the three signals 116, 118, 120 are provided by the output portion as a single communication set, but the information from the signals 116, 118, 120 is separable so that three separate reports (e.g., wear-out, health, and mission as depicted in FIGS. 6A-6C) may be generated.

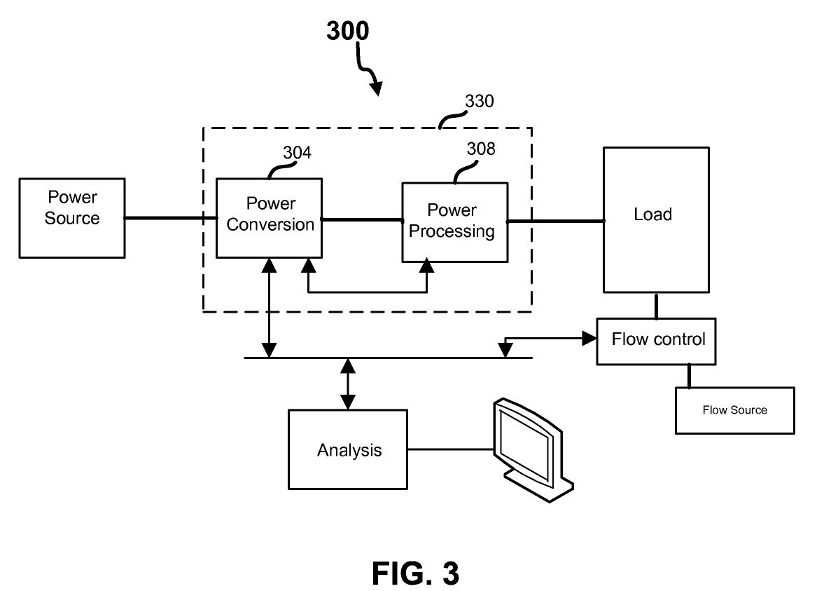

Referring next to FIG. 3, it is a block diagram depicting another embodiment of a processing system 300 in which the embodiment depicted in FIG. 1 may be employed. As shown, the system in this embodiment is the same as the system 200 depicted in FIG. 2 except that two components (e.g., the power conversion component 304 and power processing component 308) are configured to interoperate such that the two components together may communicate information (e.g., the wear-out signal 116, the health signal 118, and the mission signal 120) as a collective unit 330.

In one embodiment for example, the power conversion component 304 may be realized by a generator 304 and the power processing component 308 may be realized by an impedance match network. In this embodiment, the generator is configured to communicate information (e.g., a wear-out signal, health signal, and mission signal) for the collective unit 330. It is contemplated for example that the generator and match are communicatively coupled so that the generator receives information about measured operational and/or environmental characteristics of the match, and the generator includes the wear-out 102, health 104, and mission 106 modules described with reference to FIG. 1.

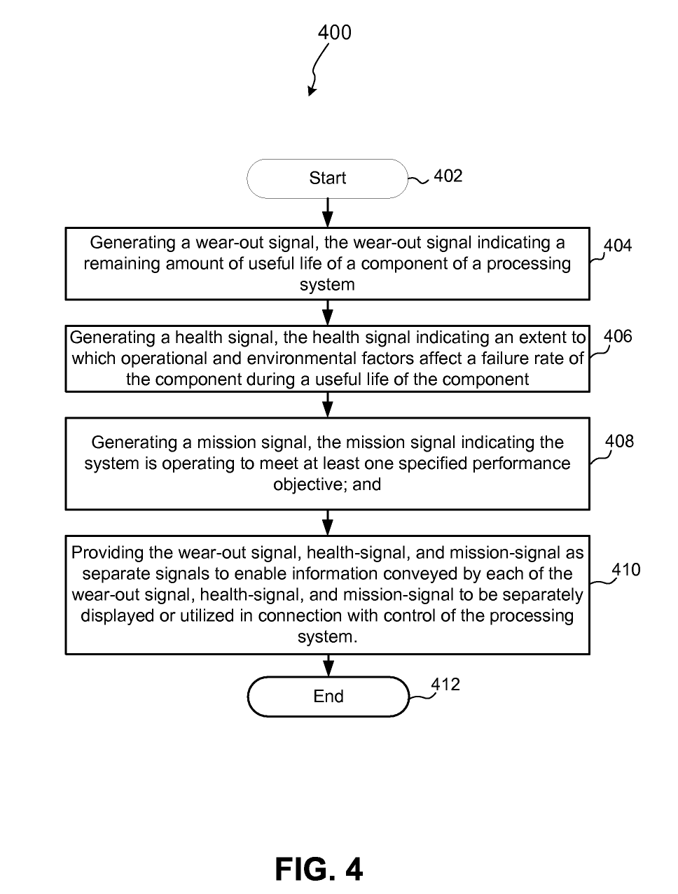

Referring next to FIG. 4, shown is a flowchart depicting an exemplary method for monitoring and reporting process system parameters that may be carried out in connection with the embodiments described with reference to FIGS. 1-3. As shown, a wear-out signal that indicates a remaining amount of useful life of a component is generated (e.g., by the wear-out module 102) (Block 404); a health signal that indicates an extent to which operational and environmental factors affect failure rate of the component is generated (e.g., by the health module 104)(Block 406); a mission signal that indicates the mission signal is operating to meet at least one specified performance objective is generated (e.g., by the mission module 106)(Block 410); and the wear-out signal, health signal, and mission signal are provided as three separable signals (e.g., by the output module 108) to enable tracking (e.g., in real time) of wear-out, product health, and mission health.

In conclusion, the present invention provides, among other things, a system and method for monitoring a processing system. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A system for managing a processing system component, comprising:
a wear-out module configured to provide a wear-out signal, the wear-out signal indicating a remaining amount of useful life of the component;
a health module configured to provide a health signal, the health signal indicating an extent to which operational and environmental factors affect a failure rate of the component during a useful life of the component; and
a mission module configured to provide a mission signal, the mission signal indicative of whether an operating condition is approaching a threshold that would adversely affect the system's ability to meet at least one performance objective;
wherein the wear-out signal, health signal, and mission signal are separately identifiable signals.

2. The system of claim 1, wherein the processing system component includes a plurality of subcomponents, and the wear-out module is configured to provide the wear-out signal so that wear-out signal indicates the probability of failure of a subcomponent that is most likely to fail.

3. The system of claim 2, wherein the subcomponents include electrical and mechanical subcomponents of the component.

4. The system of claim 3, wherein the subcomponents include subcomponents selected from the group consisting of power switching components, vacuum tubes, contactors, relays, fans, fuses, line suppressors, motors, capacitors, bearings, filters, pumps, and valves.

5. The system of claim 1, wherein the wear-out signal indicates a probability that the component will fail due to wear-out.

6. The system of claim 1, wherein the wear-out signal indicates the remaining amount of useful life of the component by indicating an amount of useful life that has been utilized.

7. The system of claim 1, wherein the health module is configured to provide the health signal as a single summary health factor, the single summary health factor derived from environmental conditions and operating conditions of a plurality of subcomponents within the component.

8. The system of claim 7, wherein the environmental conditions include environmental conditions selected from the group consisting of temperature, condensation, dust, water flow, air purity, and humidity.

9. The system of claim 7, wherein the operating conditions include operating conditions selected from the group consisting of: power cycles, power, energy, voltage, charge, current, and control stability.

10. The system of claim 1, including a self protect portion configured to initiate shutdown of the processing system component responsive to the health signal indicating the processing system component is operating within a particular proximity of an operating limit.

11. The system of claim 1, wherein the mission module is configured to generate the mission signal as a function of an extent to which each of a plurality of operating conditions approaches a corresponding one of a plurality of operating thresholds.

12. The system of claim 11, wherein at least one of the plurality of operating conditions affecting the mission signal does not affect the health signal.

13. The system of claim 11, wherein at least one of the plurality of operating conditions is an operating condition of a portion of the processing system that is external to the component.

14. The system of claim 13, wherein operating condition of the portion of the processing system that is external to the component includes an operating condition selected from the group consisting of a parameter of a power source, a parameter of a load, an electrical perturbation, a pressure perturbation, and an environmental condition.

15. The system of claim 11, wherein the operating conditions include operating conditions selected from the group consisting of load impedance, control stability, arc rate, temperature, voltage, current, power dissipation, upstream pressure, and downstream pressure.

16. The system of claim 11, wherein the operating conditions include conditions of a closed-loop control system within the processing system component.

17. The system of claim 1, wherein at least two components are communicatively coupled together so as to form a component combination, wherein the wear-out module provides a wear-out signal for the component combination, health module provides the health signal for the component combination, and the mission module provides the mission signal for the component combination.

18. A method for monitoring a processing system, comprising:
generating a wear-out signal, the wear-out signal indicating a remaining amount of useful life of a component of the processing system;
generating a health signal, the health signal indicating an extent to which operational and environmental factors affect a failure rate of the component during a useful life of the component;
generating a mission signal, the mission signal indicative of whether an operating condition is approaching a threshold that would adversely affect an ability of the component to meet at least one specified performance objective; and
providing the wear-out signal, health-signal, and mission-signal as separate signals to enable information conveyed by each of the wear-out signal, health-signal, and mission-signal to be displayed or utilized in connection with control of the processing system.

19. The method of claim 18, wherein each of the wear-out signal, health-signal, and mission-signal have at least three potential levels.

20. The method of claim 18, wherein providing the wear-out signal, health-signal, and mission-signal as separate signals includes combining the wear-out signal, health-signal, and mission-signal so as to enable the wear-out signal, health-signal, and mission-signal to be transmitted together from the component and separated at a location remote from the component.

21. The method of claim 18, including:
monitoring an environmental condition; and
monitoring operation of the component;
generating the wear-out signal, the health signal, and the mission signal as a function of the environmental condition and the operation of the component.

22. The method of claim 21, including monitoring an environmental condition selected from the group consisting of temperature, condensation, dust, air purity, and humidity.

23. The method of claim 21, wherein monitoring operation of the component includes monitoring parameters selected from the group consisting of load impedance, control stability, arc rate, temperature, voltage, current, power dissipation, upstream pressure, and downstream pressure.

24. The method of claim 21, wherein at least one operation parameter affecting the mission signal does not substantially affect the health signal.

25. The method of claim 18, wherein the component includes a component selected from the group consisting of a power generator, a matching network, an inverter, a DC-to-DC converter, mass flow controller, vaporizers, flow ratio controllers.

26. A processing system component, comprising:
a plurality of electronic and mechanical subcomponents;
a wear-out module configured to provide a wear-out signal, the wear-out signal indicating a remaining amount of useful life of the component;
a health module configured to provide a health signal, the health signal indicating an extent to which operational and environmental factors affect a failure rate of the component during a useful life of the component; and
a mission module configured to provide a mission signal, the mission signal indicative of whether an operating condition is approaching a threshold that would adversely affect an ability of the component to meet at least one specified performance objective;
wherein the wear-out signal, health signal, and mission signal are separately identifiable signals.

27. The processing system component of claim 26, wherein the wear-out module, health module, and mission module are realized by a processor configured to execute processor-readable instructions from memory.
